(19) United States
(12) Patent Application Publication
(10) Pub. No.: US 2017/0107149 A1
(43) Pub. Date: Apr. 20, 2017

(54) STABLE PCE AND POLYSACCHARIDE VMA COMPOSITIONS FOR CONCRETE ADMIXTURES AND THEIR USES

(71) Applicant: Dow Global Technologies LLC, Midland, MI (US)

(72) Inventors: Robert Baumann, Rueschlikon (CH); Marc Schmitz, Verden/Aller (DE); Anette Wagner, Walsrode (DE)

(73) Assignees: Dow Europe GmbH, Horgen (CH); Dow Wolff Cellulosics GmbH & Co. OHG, Bomlitz (DE); The Dow Chemical Company, Midland, MI (US)

(21) Appl. No.: 15/127,982

(22) PCT Filed: Mar. 27, 2015
(86) PCT No.: PCT/US2015/023034

§ 371 Date: Sep. 21, 2016

Related U.S. Application Data
(60) Provisional application No. 61/971,715, filed on Mar. 28, 2014.

(51) Int. Cl. C04B 24/38; C04B 24/26; C04B 40/00; C04B 28/04

(52) U.S. Cl. CPC C04B 24/383; C04B 28/04; C04B 24/2647; C04B 40/0039; C04B 2103/44

(57) ABSTRACT

The present invention provides aqueous compositions that are stable after at least a 24 hour period comprising a polysaccharide viscosity modifying additive and more than 60 wt. %, based on the weight of total solids in the compositions of one or more polycarboxylate ether, the compositions comprising an acid chosen from an organic acid having 1 hydroxy group or less, a strong acid containing a single hydrogen, an ascorbic acid, and mixtures thereof, the compositions having a pH of less than the pH of the polycarboxylate ether itself, or from 1.0 to 6.0. The present invention enables stable concentrates of aqueous polycarboxylate ethers and polysaccharide viscosity modifying agents for use in hydraulic binder applications, the compositions having a total solids content of 10 wt. % to as high as 65 wt. %.

The present invention relates to stable aqueous concentrates comprising one or more polysaccharide viscosity modifying additive, one or more polycarboxylate ether and at least one acid chosen from organic acids having 1 hydroxy group or less, strong acids containing a single hydrogen and ascorbic acids. More particularly, it relates to stable aqueous polycarboxylate ether concentrate compositions having a pH below that of the polycarboxylate ether, for example, from 1.0 to 6.0 or, preferably, 5.5 or less, or, more preferably, 4.5 or less, and comprising more than 60 wt. %, or, preferably, 63 wt. % or more, based on the total solids in the composition, of the one or more polycarboxylate ether. Finally, it relates to methods of using the compositions in cement or concrete admixtures.

Viscosity Modifying Agents (VMAs) are well known as additives for the concrete production. They are added in very small amounts compared to the inorganic ingredients such as cement, fly ash, limestone powder, sand and gravel. Accordingly, using VMAs in dry powder form presents mixing issues for concrete producers. A liquid dosage of VMA is much easier for concrete producers to use. However, mixing polysaccharide containing VMAs with water reducers, especially, polycarboxylate ether (PCE) superplasticizers leads to precipitation of the two and a homogeneous dosage into the concrete becomes impossible. One pressing need for the concrete industry then is to overcome the solution compatibility issues of PCE superplasticizers in combination with polysaccharide containing viscosity modifying agents, like cellulose ethers.

WIPO publication WO2009024105A1, to Maier, discloses additive compositions for mineral-bound building materials, wherein the additive composition (A) 5 to 50 wt. % of at least one air-entraining agent, (B) 5 to 50 weight. % of at least one thickening agent, (C) 10 to 60 wt. % of at least one condenser, (D) 5 to 40 wt. % of at least one flow aid; and (E) 5 to 50 weight. % of at least one stabilizer. In addition, other ingredients such as polymer dispersions or powders, cure accelerators and hydrophobic agents may be added at 5 wt. % of solids or higher. Maier fails to disclose any shelf stable composition comprising a polycarboxylate ether and a polysaccharide VMA and fails to address the precipitation problem that results when polysaccharide containing VMAs and polycarboxylate ether (PCE) superplasticizers are combined in an aqueous composition form.

The present inventors have endeavored to solve the problem of providing a stable 1-component aqueous compositions of polysaccharide containing viscosity modifying agents together with a polycarboxylate ether (PCE) superplasticizer for use in cement compositions.

### STATEMENT OF THE INVENTION

1. In accordance with the present invention, shelf stable aqueous compositions comprise one or more polysaccharide viscosity modifying additive, one or more polycarboxylate ether (PCE), and an acid chosen from organic acids having 1 hydroxy group or less, preferably, those organic acids having no hydroxyl groups, strong acids containing a single hydrogen, and ascorbic acids, wherein the pH value of the aqueous compositions are below the pH of the polycarboxylate ether, and, further wherein, the aqueous compositions comprise more than 60 wt. %, such as more than 60.1 wt. %, or, preferably, 63 wt. % or more, based on the total solids in the composition, of the one or more polycarboxylate ether.

2. The aqueous composition of 1, above, may comprise the polysaccharide viscosity modifying additive in an amount of from 1 to 40. wt. %, preferably, from 2 to 36 wt. %, or, more preferably, from 2 to 20 wt. %, based on the total solids in the composition.

3. In the aqueous compositions of 1 or 2, above, the polysaccharide viscosity modifying additive and the polycarboxylate ether solids of the composition may comprise more than 70 wt. % of the total solids of the composition, or, preferably, more than 75 wt. % of the total solids in the composition.

4. In the aqueous compositions of any of 1, 2 or 3, above, the total solids of the aqueous compositions comprises from 10 to 65 wt. %, or, preferably, from 15 to 55 wt. %, or, more preferably, from 15 to 50 wt. %.

5. In the aqueous compositions of any of 1, 2, 3 or 4, above, the polysaccharide viscosity modifying additive is preferably chosen from cellulose ethers.

6. In the aqueous compositions of any of 1, 2, 3, 4 or 5, above, wherein the pH value of the aqueous compositions ranges from 1.0 to 6.0, or, preferably, below 5.5, or, more preferably, below 4.5 or more than 2.0.

7. In the aqueous compositions of any of 1, 2, 3, 4, 5 or 6, above, the organic acid having 1 hydroxy group or less may be a monocarboxylic acid, such as, for example, a C₁ to C₆ carboxylic acid, like formic acid, acetic acid, butyric acid, isobutyric acid, pentanoic acids, and caproic acid; a dicarboxylic acid, such as, for example, malonic acid, succinic acid, pentanedioic acids, and adipic acid; a ketocarboxylic acid, such as pyruvic acid and oxaloacetic acid; a hydroxy dicarboxylic acid, such as, for example, malic acid; a polycarboxylic acid, such as, for example, metallic acid and trimellitic acid; a hydroxy polycarboxylic acid, such as, for example, citric acid; a strong acid containing a single hydrogen, such as, for example, hydrochloric acid, hydriodic acid and hydrobromic acid; and ascorbic acids, such as ascorbic acid and iso-ascorbic acid.

8. In another aspect of the present invention, methods of making the aqueous compositions of any of 1, 2, 3, 4, 5, 6, or 7, above, comprise combining an aqueous mother liquor of a polycarboxylate ether with a powder of a polysaccharide viscosity modifying additive and the acid, in any order, in the presence of shear to form a visibly homogeneous composition.

9. In another aspect of the present invention, methods of using the aqueous compositions of any of 1, 2, 3, 4, 5, 6, or 7, above, comprise combining the aqueous composition with hydraulic binder in the presence of shear to form a mortar, applying the mortar to a substrate. The applied mortar may further be allowed to cure.

As used herein, the phrase “aqueous” includes water and mixtures composed substantially of water and water-miscible solvents, preferably, such mixtures having more than 50 wt. % water, based on the total weight of water and any water-miscible solvents.

As used herein, the phrase “based on total solids” refers to weight amounts of any given ingredient in comparison to the total weight amount of all of the non-volatile ingredients in the aqueous composition, including the viscosity modifying additive, polycarboxylate ether, acids, defoamers, emulsion copolymer(s), and other non-volatile additives. Water, ammonia and volatile solvents are not considered solids.

As used herein, the phrase “hydraulic binder” means any inorganic material that cures in the presence of moisture, including, for example, cement, pozzolans, gypsum, geopolymers and alkaline silicates, such as water glass.

As used herein, the phrase “mortar” means a wet trowelable or pourable mixture containing hydraulic binder.

As used herein, the term “acrylic or vinyl polymer” refers to polymers of ethylenically unsaturated carboxylic acids, carboxylic anhydrides, and salts thereof, such as acrylic or methacrylic acid, itaconic acid, maleic acid, fumaric acid and their salts and anhydrides, and polymers of polyglycol methacrylates, such as, for example, methoxypolyethylene glycol methacrylate (MPEGMA). As used herein, the term “based on the total weight of monomers” refers to the total weight of addition monomers, such as, for example, vinyl monomers.

As used herein, unless otherwise indicated, the phrase “polymer” includes both homopolymers and copolymers from two or more than two differing monomers, as well as segmented and block copolymers.

As used herein, “wt. %” or “wt. percent” means weight percent based on solids.

The singular forms “a,” “an,” and “the” include plural referents unless the context clearly dictates otherwise. Unless defined otherwise, technical and scientific terms used herein have the same meaning as is commonly understood by one skilled in the art.

Unless otherwise indicated, any term containing parentheses refers, alternatively, to the whole term as if no parentheses were present and the term without that contained in the parentheses, and combinations of each alternative. Thus, the term “(meth)acrylate” encompasses, in the alternative, methacrylate, or acrylate, or mixtures thereof.

The endpoints of all ranges directed to the same component or property are inclusive of the endpoint and independently combinable. Thus, for example, a disclosed range of pH value of from 1.0 to 6.0, or, preferably, below 5.5, or, more preferably, below 4.5 or more than 2.0 means any of a pH of from 1.0 to 6.0, or from 5.5. to 6.0, or, from 1.0 to 2.0, or, from 2.0 to 6.0, or, from 4.5 to 6.0, or, preferably, from 4.5 to 5.5, or, preferably, from 1.0 to 5.5, or, preferably, from 2.0 to 5.5, or, preferably, from 1.0 to 4.5, or, preferably, from 4.5 to 5.5, or, more preferably, from 2.0 to 4.5.

Unless otherwise indicated, conditions of temperature and pressure are room temperature and standard pressure, also referred to as “ambient conditions”. The aqueous binder compositions may be dried under conditions other than ambient conditions.

In accordance with the present invention, concentrated aqueous compositions comprise a single liquid additive containing both a polysaccharide as a VMA, e.g. cellulose ether, and polycarboxylate ether with polyethylene glycol side chains as water reducer. Such mixtures are known to precipitate in water even when the polycarboxylate ether is present in salt form. The inventive aqueous compositions enable the remote or on site preparation of concrete admixtures from a single shelf stable (24 hour) liquid additive having a VMA and a polycarboxylate ether. Before the present invention, a user would have to add the VMA and the polycarboxylate ether separately to a cement admixture. The present inventors have discovered that much improved stability is achieved in these compositions by addition of organic acids having 1 hydroxy group or less, preferably, those organic acids having no hydroxyl groups, strong acids containing a single hydrogen, e.g. HCl, and ascorbic acids, which are added to the solution of the two polymers in order to reduce the pH level, such as to below 5, preferably to 4, most preferably to as low as 1, in order to prevent the composition from precipitating out. The aqueous composition of the present invention also enables one to store and use as needed a concentrated viscosity modifying additive which has up to 15 wt. % of the viscosity modifying additive, based on the total solids of the aqueous composition.

Suitable viscosity modifying additives for use in the present invention may be cellulose ethers such as hydroxyalkyl celluloses, like hydroxyethyl cellulose (HEC), hydroxyethyl methyl cellulose (HEMC), hydroxypropyl methyl cellulose (HPMC), and ethyl hydroxyethyl cellulose (EHEC); methyl cellulose (MC). Preferably, the viscosity modifying additives are hydroxylalkyl celluloses, hydroxyethyl methyl cellulose (HEMC), hydroxypropyl methyl cellulose (HPMC), and ethyl hydroxyethyl cellulose (EHEC).

Where methyl cellulose and gums are used as the viscosity modifying additive, ascorbic acids are preferred.

Aqueous compositions of anionic viscosity modifying additives when mixed with polycarboxylate ethers may precipitate out and are not included in the scope of the present invention. Anionic viscosity modifying additives include carboxy methyl cellulose (CMC).

Suitable useful amounts of viscosity modifying additives that give stable aqueous compositions of the present invention may vary with the amount of acid added. The upper limit is determined by whether the aqueous compositions are reasonably free of precipitate and remain pourable. For preferred viscosity modifying additives, the amounts used in the aqueous composition of the present invention may range as high as 40.1 wt. %, based on the total solids in the aqueous composition.

Suitable polycarboxylate ethers (PCEs) for use in the present invention may include any acrylic or vinyl comb polymer that has carboxylic acid and or salt groups and polyether or alkyl polyether side chains, preferably, alkoxy (poly)oxyalkylene side chains. The polycarboxylate ethers generally have a pH of from 5.7 to about 8. Suitable alkoxy (poly)oxyalkylene functional side chains for the polycarboxylate ethers of the present invention can have from 1 to 500, preferably, 100 or less or 6 or more, or, more preferably, from 10 to 50 oxyalkylene groups. The alkoxy group of the side chain may have from 1 to 20 carbon atoms.

The polycarboxylate ethers of the present invention may be synthesized by conventional aqueous solution, emulsion or suspension polymerization of addition polymerizable monomers in the presence of a thermal initiator, such as a persulfate, or a redox catalyst pair, such as a peroxide and a bisulfite compound, optionally with a conventional chain transfer agent, to make a polycarboxylate ether (monomer approach) or to make a polymeric polyacid intermediate followed by esterification and amidation (grafting approach) in a conventional process comprising heating and mixing together the polymeric polyacid with one or more alkoxy (poly)oxyalkylene glycol or the amine of such a glycol.

For the grafting approach to making polycarboxylate ethers, the polymeric polyacids may be formed by aqueous solution polymerization of ethylenically unsaturated C₃-C₆ monocarboxylic acids or their salts such as acrylic acid, methacrylic acid, crotonic acid, isocrotonic acid, 2-ethylpropenoic acid; ethylenically unsaturated C₄-C₆-dicarboxylic acids such as maleic acid, fumaric acid, itaconic acid, citraconic acid and the salts of any such monocarboxylic and dicarboxylic acids, in particular the sodium, potassium or ammonium salts; the anhydrides of the ethylenically unsaturated C₄-C₆ dicarboxylic acids, e.g. maleic anhydride, itaconic anhydride, citraconic anhydride. Preferably, the polymeric polyacids are acids polyacrylic acid, polymethacrylic acid or copolymers of acrylic acid (AA) and methacrylic acid (MAA) and their salts or partial salts. The esterification and amidation of any polymeric polyacid is a conventional process comprising heating and mixing together the hypophosphite (co)telomers of methacrylic anhydride with alkoxy(poly)oxyalkylene glycol or the amine of such a glycol.

Suitable alkoxy(poly)oxyalkylene functional side chains for the polymeric polyacids of the present invention can have from 1 to 500, preferably, 100 or less or 6 or more, or, preferably from 10 to 50 oxyalkylene groups. The alkoxy group of the side chain may have from 1 to 20 carbon atoms. Examples of suitable glycols for amidation or esterification are methoxypolyethylene glycol and methoxy-polyethylene glycol-polypropylene glycol, and polyethylene glycol.

For the monomer approach, polycarboxylate ethers may be addition copolymers of the of ethylenically unsaturated C₃-C₆ monocarboxylic acids or their salts or anhydrides with carboxylate ether containing monomers, such as, for example, polyethylene glycol (meth)acrylate or its corresponding (meth)acrylamide, polypropylene glycol (meth)acrylate or its corresponding (meth)acrylamide, polybutylene glycol mono(meth)acrylate or its corresponding (meth)acrylamide, polyethylene glycol-polypropylene glycol mono(meth)acrylate or its corresponding (meth)acrylamide, polyethylene glycol-polybutylene glycol (meth)acrylate or its corresponding (meth)acrylamide, polypropylene glycol-polybutylene glycol (meth)acrylate or its corresponding (meth)acrylamide, polyethylene glycol-polypropylene glycolpolybutylene glycol (meth)acrylate or its corresponding (meth)acrylamide, methoxypolyethylene glycol (meth)acrylate or its corresponding (meth)acrylamide, methoxypolyethylene glycol, methoxypolypropylene glycol (meth)acrylate or its corresponding (meth)acrylamide, methoxypolybutylene glycol (meth)acrylate or its corresponding (meth)acrylamide, methoxypolybutylene glycol mono(meth)acrylate or its corresponding (meth)acrylamide, methoxypolyethylene glycol polypropylene glycol (meth)acrylate or its corresponding (meth)acrylamide, methoxypolyethylene glycol-polybutylene glycol (meth)acrylate or its corresponding (meth)acrylamide, methoxypolypropylene glycol-polybutylene glycol (meth)acrylate or its corresponding (meth)acrylamide, methoxypolyethylene glycol-polypropylene glycol-polybutylene glycol (meth)acrylate or its corresponding (meth)acrylamide, ethoxypolyethylene glycol (meth)acrylate or its corresponding (meth)acrylamide, polyethylene glycol (meth)allyl ether or monovinyl ether, polypropylene glycol (meth)allyl ether or monovinyl ether, polyethylene glycol-polypropylene glycol (meth)allyl ether or monovinyl ether, polyethylene glycol-polybutylene glycol (meth)allyl ether or monovinyl ether, polypropylene glycolpolybutylene glycol (meth)allyl ether or monovinyl ether, methoxypolyethylene glycol (meth)allyl ether or monovinyl ether, methoxypolypropylene glycol (meth)allyl ether or monovinyl ether, and the corresponding monoesters, monoamides, diesters and diamides of itaconic or maleic acids, or mixtures of any of the foregoing.

A suitable polycarboxylate ether can that sold as Glenium™ 51 polymer (BASF, Leverkusen, Del.).

Generally, the polycarboxylate ether is available as an aqueous mother liquor having from 25 to 40 wt. % solids in water.

The polycarboxylate ether comprises more than 60 wt. %, of total solids in the composition, or, preferably, more than 63 wt. % or, more preferably, 65 wt. % or more.

The acid of the present invention may be any organic acids having 1 hydroxy group or less, such as, for example, carboxylic acids, polycarboxylic acids, hydroxycarboxylic acids having one hydroxyl group, or, preferably, organic acids having no hydroxyl groups, strong acids containing a single hydrogen, and ascorbic acids, like D-iso-ascorbic acid.

Strong polyprotic acids, like sulfuric acid or phosphoric acid, and acids with two hydroxyl groups do not enable a stable aqueous composition in accordance with the present invention.

Preferably, if the viscosity modifying additive is a gum or methyl cellulose, the acid is an ascorbic acid.

Preferably, the aqueous compositions of the present invention comprise 75 wt. % or more, based on the total solids in the composition, of the total amount of the one or more viscosity modifying additive, the one or more polycarboxylate ether and the acid or, preferably, 80 wt. % or more.

The aqueous compositions of the present invention can contain, in addition, conventional additives, such as, for example, cement setting accelerators and retarders, air entrainment agents or defoamers, shrinking agents and wetting agents; surfactants, particularly nonionic surfactants; spreading agents; mineral oil dust suppressing agents; biocides; plasticizers; organosilanes; anti-foaming agents such as dimethicones and emulsified poly(dimethicones), silicone oils and ethoxylated nonionics; and coupling agents such as, epoxy silanes, vinyl silanes and hydrophobic silanes.

The methods of making the aqueous compositions of the present invention comprise combining the viscosity modifying additive with the aqueous polycarboxylate ether composition or mother liquor and the acid, with or following by stirring or shear to form the aqueous composition. Any additives may then be incorporated in appropriate amounts not to exceed a total of 25 wt. % of the total solids in the composition.

The aqueous compositions may be used by admixing them with hydraulic binders to make plasters, cements, concrete or mortars.

### EXAMPLES

The following examples serve to illustrate the invention. Unless otherwise indicated, the preparations and test procedures are carried out at ambient conditions of temperature and pressure.

Compatibility:

To check the compatibility of polysaccharide viscosity modifying additives (VMAs) and the polycarboxylate ether (PCE) superplasticizer, the VMAs were added in solid form to the superplasticizer in a glass container during stirring using a magnetic stirrer. The original pH of the investigated polycarboxylate ether aqueous composition solution is around pH 6. When adding a VMA (see Table 1, below) in solid form to this superplasticizer solution a precipitation was observed. The investigated VMA's were not compatible with the superplasticizer. After adjusting the pH of this mixture to a value of pH 5 using acetic acid, a stable solution without precipitates was observed.

Performance of acidified 1K PCE/VMA aqueous compositions was tested by adding the compositions in Table 1, below, to a mortar system containing 50 g cement. To compare performance of the aqueous compositions with standard dosage uses of viscosity modifying additives, the same VMA is added to the sand/cement mix as a dry powder, separately from a superplasticizer, and the fresh mortar properties (slump and bleeding) were tested twice for each example.

Slump:

A measure of how much a mortar is able to flow under its own weight after 15 strokes on a jolting table according to DIN EN 1015-3:2007-05 (Beuth Verlag GmbH, Berlin, Del., 2007), by placing a cone funnel (slump cone) having a bottom opening diameter of 100 mm, a top opening diameter of 70 mm and a height of 60 mm with the bottom opening on a wetted glass plate (wetted 10 seconds before testing), filling the cone with mortar and then quickly pulling the cone vertically off from the plate to fully release the mortar onto the plate of a Jolting Table (available from Toni Technik, Berlin, Del.) followed by subjecting the mortar to 15 strokes. Once the mortar ceases to spread, measure the diameter of the resulting mortar cake in four locations spaced equally around the mortar cake. The average of the four diameters is the slump value for the mortar. An acceptable result is a slump value that does not differ more than 30 mm from the slump value obtained by the same composition when the same amount of the same polycarboxylate ether and the same amount of the same viscosity modifying agent are separately added to the composition, preferably not more than 20 mm, or, more preferably, not more than 15 mm.

Table 1, below, gives compositions of viscosity modifying additives added to 5 g of GLENIUM™ 51 polymer (a partially neutralized 37 wt. % solids aqueous solution of a sodium polycarboxylate ether BASF, Leverkusen, Del., pH 7±1). These compositions were used in full to prepare an aqueous composition in a mortar formula containing 500 g cement.

TABLE 1
VMA-PCE Compositions (4C-5C are Comparative)

| | | VMA Quantity |
|---|---|---|
| | | added to 5 g |
| Example | VMA | GLENIUM ® 51 |
| 1A | Cellosize ™ QP 4400 H (HEC)¹ | 0.250 g |
| 2A | Walocel ™ MKX 6000 PF 01 (HEMC)¹ | 0.250 g |
| 3A | Methocel ™A4M (MC)¹ | 0.250 g |
| 4C | Sika Stabilizer 4R (Starch Ether) | 3.846 g* |
| 5C | Kelco-Crete ™ 80 (Diutan Gum) | 0.250 g |

*Sika Stabilizer 4R is supplied as a solution having a solids content of 6.5 wt. %; 1. HEC MS = 2.0, viscosity = 4400-6000 cP (2 aqu. solution, #4 SPINDLE @ 60 RPM): HEMC DS = 1.5-1.75, MS = 0.22-0.33, viscosity = 5500-7000 mPas (ROTOVISKO, D = 2.55 sec−1, 2 aqu. solution, 20° C.) The Dow Chemical Co., Midland, MI, USA 2. Sika AG, Baar (ZG), CH, 3. CP-Kelco, Atlanta, GA, USA.

The mortars tested contained the materials shown in Table 2, below. To prepare mortars for testing, first all of the dry components were added together and mixed to make a dry mix. Then the water and polycarboxylate ether or polycarboxylate ether mixture from Table 1, above, with viscosity modifying additive was added into the mixing bowl of a ToniMIX™ mixer (available from Toni Technik, Berlin, Del.). While mixing, the dry mix was added to the mixing bowl, mixing for 30 seconds on level one and then for 30 seconds on level two (higher speed). After allowing the mixture to rest for 90 seconds to dissolve soluble additive, the mortar was then mixed again for 60 seconds on level two. The resulting mixture serves as a mortar. The results are shown in Table 3, below. As shown in Table 3, below, with a pH adjustment to pH 5 the aqueous composition of the present invention becomes homogeneous without precipitations. Comparing the performance of the conventional, separate addition of VMA and PCE in the formulation with addition of the aqueous composition of VMA and PCE adjusted to pH5, it can be seen that they all perform equally well. The slump value is in the preferred range for all examples tested and the formulations do not bleed. Thus, adjusting the aqueous composition pH to 5 with acetic acid results in a homogeneous mixture which still performs.

TABLE 2
Mortar Formulation and Results

| Component | Identity | Mass |
|---|---|---|
| Cement | Heidelberger PUR CEM I 42.5 R, | 500.0 g |
| | Heidelberg, DE | |
| Water/Cement | | 0.5 |
| Superplasticizer | Glenium ™ 51 polycarboxylate | 5.0 g or See |
| | ether (BASF, Ludwigshafen, DE)) | table 1 |
| VMA | See Table 1 | See table 1 |
| Aggregate 1 | Quarzsand H32 from Quarzwerke | 500.0 g |
| | GmbH, Frechen, DE. | |
| Aggregate 2 | Sand having a particle size of | 600.0 g |
| | 0.1-1.0 mm (M.u.E. Tebbe-Neuenhaus | |
| | OHG, Bottrop, DE) | |
| Aggregate 3 | Sand having a particle size of | 400.0 g |
| | 1.0-2.0 mm (M.u.E. Tebbe-Neuenhaus | |
| | OHG Bottrop, DE) | |

TABLE 3
Results

| | Appearance | | | | | |
|---|---|---|---|---|---|---|
| | of the | | | | | |
| | VMA/PCE | | Slump | | Bleeding | |
| | Mixture | | separate | VMA/ | separate | VMA/ |
| | original | | Addition of | PCE | Addition | PCE |
| | pH (not | at | VMA and | Mixture | of VMA | Mixture |
| Example | adjusted) | pH 5 | PCE | at pH 5 | and PCE | at pH 5 |
| 1A | precipitate | stable | 216 | 212 | No | No |
| 2A | precipitate | stable | 214 | 226 | No | No |
| 3A | precipitate | stable | 235 | 236 | No | No |
| 4C¹ | precipitate | stable | 158 | 170 | No | No |
| 5C¹ | precipitate | stable | 171 | 175 | No | No |
| 6C¹ w/o | stable | n.a. | 236 | n.a. | Yes | n.a. |
| VMA | | | | | | |

¹Comparative Example.

Shelf Stability:

To test the shelf stability of the aqueous compositions of the present invention, the indicated mixtures of the polycarboxylate ether and the viscosity modifying additive, with proportions indicated in Tables 4 and 5, below, were acidified with the indicated acid and checked for stability, then let to stand for about 24 hours and rechecked for stability and pourability. Stable compositions are labeled as “stable” and unstable compositions are labelled “precipitate”. A pourable composition was labeled as “x” and a composition that was too viscous to pour was labeled “o”, which is unacceptable.

As shown in Tables 4, 5, and 6, below, a variety of acids and viscosity modifying additives can be included in the aqueous compositions of the present invention to give a stable concentrate for one to add to mortar or cement. In general, acids with two hydroxyl groups failed to give a stable aqueous composition. See Comparative Examples 49-52 with tartaric acid. The exception was the ascorbic acids which had only 1 carboxyl group and are easily oxidized to eliminate at least two of its hydroxyl groups. See Examples 33-36, 41-44 and 58. Examples 53-57 and 59-60 show that methyl cellulose is not a preferred viscosity modifying additive, but works with ascorbic acid in the aqueous composition at a pH below 5. Starch ethers are not preferred but give stable mixes on mixing. See Comparative Examples 61-73.

As shown in Tables 4, 5 and 6, below, all inventive Examples were stable and pourable after 24 hours. Comparative Examples 4 and 8 show clearly that polyprotic strong acids will not even give stable aqueous compositions of just a polycarboxylate ether. As shown in Comparative Examples 18-19 and 27-28, too high a solids content of the polysaccharide VMA results in compositions that are not pourable and cannot be used in accordance with the present invention. As shown in Comparative Examples 45-48, strong polyprotic acids fail to give stable compositions in accordance with the present invention. As shown in Comparative Examples 49-52, carboxylic acids with two hydroxyl groups fail to give stable compositions in accordance with the present invention. As shown in Comparative Examples 53-57, and inventive Example 58, ascorbic acids give stable compositions of polycarboxylate ether and methyl cellulose, especially at a lower pH. Finally, as shown in Comparative Examples 61-73, diutan gums fail to give stable compositions in accordance with the present invention.

TABLE 4
Shelf Stability Results (All Examples contain PCE¹)

| Example | | | | Upon | Pour- | | Pour- |
|---|---|---|---|---|---|---|---|
| (VMA) | Wt. %¹ | Acid | pH | Mixing | able | after 24 hr | able |
| 1* (none) | No VMA | HCl | 5 | stable | x | stable | X |
| 2* (none) | No VMA | citric acid | 5 | stable | x | stable | X |
| 3* (none) | No VMA | acetic acid | 5 | stable | x | stable | X |
| 4* (none) | No VMA | sulfuric acid | 5 | precipitate | x | precipitate | X |
| 5* (none) | No VMA | formic acid | 5 | stable | x | stable | X |
| 6* (none) | No VMA | succinic acid | 5 | stable | x | stable | X |
| 7* (none) | No VMA | D-iso-ascorbic acid | 5 | stable | x | stable | X |
| 8* (none) | No VMA | phosphoric acid | 5 | stable | x | precipitate | X |
| 9* (none) | No VMA | tartaric acid | 5 | stable | x | stable | X |
| 10* (HEMC²) | 2.5 | w/o | 6 | stable | x | precipitate | X |
| 11* (HEMC²) | 5.0 | w/o | 6 | stable | x | precipitate | X |
| 12 (HEMC²) | 2.5 | HCl | 5 | stable | x | stable | X |
| 13 (HEMC²) | 2.5 | HCl | 4 | stable | x | stable | X |
| 14 (HEMC²) | 5.0 | HCl | 5 | stable | x | stable | X |
| 15 (HEMC²) | 5.0 | HCl | 4 | stable | x | stable | X |
| 16 (HEMC²) | 10.0 | HCl | 5 | stable | x | stable | X |
| 17 (HEMC²) | 10.0 | HCl | 4 | stable | x | stable | X |
| 18* (HEMC²) | 20.0 | HCl | 5 | stable | ∘ | stable | ◯ |
| 19* (HEMC²) | 20.0 | HCl | 4 | stable | ∘ | stable | ◯ |
| 20 (HEMC²) | 2.5 | citric acid | 5 | stable | x | stable | X |
| 21 (HEMC²) | 5.0 | citric acid | 5 | stable | x | stable | X |
| 22 (HEMC²) | 5.0 | citric acid | 4 | stable | x | stable | X |
| 23 (HEMC²) | 10.0 | citric acid | 5 | stable | x | stable | X |
| 24 (HEMC²) | 10.0 | citric acid | 4 | stable | x | stable | X |
| 25 (HEMC²) | 12.5 | citric acid | 5 | stable | x | stable | X |
| 26 (HEMC²) | 15.0 | citric acid | 5 | stable | x | stable | X |
| 27* (HEMC²) | 17.5 | citric acid | 5 | stable | ∘ | stable | ◯ |
| 28* (HEMC²) | 20.0 | citric acid | 5 | stable | ∘ | stable | ◯ |
| 21 (HEMC²) | 5.0 | acetic acid | 5 | stable | x | stable | X |
| 22 (HEMC²) | 10.0 | acetic acid | 5 | stable | x | stable | X |
| 23 (HEMC²) | 5.0 | sulfuric acid | 4 | precipitate | x | precipitate | X |
| 24 (HEMC²) | 10.0 | sulfuric acid | 5 | precipitate | x | precipitate | X |
| 25 (HEMC²) | 5.0 | formic acid | 5 | stable | x | stable | X |
| 26 (HEMC²) | 5.0 | formic acid | 4 | stable | x | stable | X |

¹Wt. % VMA on the basis of total VMA plus PCE (Glenium ™ 51 polymer, BASF, 37 wt. % solids);
²2. Walocel ™ MKX 6000 PF 01 (Dow);
*Comparative Example.

TABLE 5
Shelf Stability Results (All Examples contain PCE¹)

| Example | | | | Upon | Pour- | after | Pour- |
|---|---|---|---|---|---|---|---|
| (VMA) | Wt. %¹ | Acid | pH | Mixing | able | 24 hr | able |
| 27 (HEMC²) | 10.0 | formic acid | 5 | stable | x | stable | X |
| 28 (HEMC²) | 10.0 | formic acid | 4 | stable | x | stable | X |
| 29 (HEMC²) | 5.0 | succinic acid | 5 | stable | x | stable | X |
| 30 (HEMC²) | 5.0 | succinic acid | 4.3 | stable | x | stable | X |
| 31 (HEMC²) | 10.0 | succinic acid | 5 | stable | x | stable | X |
| 32 (HEMC²) | 10.0 | succinic acid | 4.3 | stable | x | stable | X |
| 33 (HEMC²) | 5.0 | ascorbic acid | 5 | stable | x | stable | X |
| 34 (HEMC²) | 5.0 | ascorbic acid | 4.4 | stable | x | stable | X |
| 35 (HEMC²) | 10.0 | ascorbic acid | 5 | stable | x | stable | X |
| 36 (HEMC²) | 10.0 | ascorbic acid | 4.4 | stable | x | stable | X |
| 37 (HEMC²) | 5.0 | malic acid | 5 | stable | x | stable | X |
| 38 (HEMC²) | 5.0 | malic acid | 4 | stable | x | stable | X |
| 39 (HEMC²) | 10.0 | malic acid | 5 | stable | x | stable | X |
| 40 (HEMC²) | 10.0 | malic acid | 4 | stable | x | stable | X |
| 41 (HEMC²) | 5.0 | D-iso-ascorbic acid | 5 | stable | x | stable | X |
| 42 (HEMC²) | 5.0 | D-iso-ascorbic acid | 4.4 | stable | x | stable | X |
| 43 (HEMC²) | 10.0 | D-iso-ascorbic acid | 5 | stable | x | stable | X |
| 44 (HEMC²) | 10.0 | D-iso-ascorbic acid | 4.4 | stable | x | stable | X |
| 45* (HEMC²) | 5.0 | phosphoric acid | 5 | stable | x | precipitate | X |
| 46* (HEMC²) | 5.0 | phosphoric acid | 4 | precipitate | x | precipitate | X |
| 47* (HEMC²) | 10.0 | phosphoric acid | 5 | stable | x | precipitate | X |
| 48* (HEMC²) | 10.0 | phosphoric acid | 4 | precipitate | x | precipitate | X |
| 49* (HEMC²) | 5.0 | tartaric acid | 5 | stable | x | precipitate | X |
| 50* (HEMC²) | 5.0 | tartaric acid | 4 | stable | x | precipitate | ◯ |
| 51* (HEMC²) | 10.0 | tartaric acid | 5 | stable | x | precipitate | X |
| 52* (HEMC²) | 10.0 | tartaric acid | 4 | stable | x | precipitate | ◯ |
| 53* (MC)³ | 5.0 | citric acid | 5 | stable | x | precipitate | X |
| 54* (MC)³ | 10.0 | citric acid | 5 | stable | x | precipitate | X |
| 55* (MC)³ | 5.0 | succinic acid | 5 | stable | x | precipitate | X |
| 56* (MC)³ | 5.0 | ascorbic acid | 5 | stable | x | precipitate | X |
| 57* (MC)3 | 10.0 | ascorbic acid | 5 | stable | x | precipitate | X |
| 58 (MC)³ | 10.0 | ascorbic acid | 4.4 | stable | x | stable | X |
| 59* (MC)³ | 5.0 | malic acid | 5 | stable | x | precipitate | X |
| 60* (MC)³ | 10.0 | malic acid | 5 | stable | x | precipitate | X |

¹Wt. % VMA on the basis of total VMA plus PCE (Glenium ™ 51 polymer, BASF, 37 wt. % solids);
²Walocel ™ MKX 6000 PF 01 HEMC (Dow);
³Methocel ™ A4M methyl cellulose (Dow);
*Comparative Example.

TABLE 6
Shelf Stability Results (All Examples contain PCE¹)

| Example | | | | Upon | Pour- | | Pour- |
|---|---|---|---|---|---|---|---|
| (VMA) | Wt. %¹ | Acid | pH | Mixing | able | 24 hr | rable |
| 61*^{,2} | 2.5 | citric acid | 5 | stable | x | precipitate | x |
| 62*^{,2} | 2.5 | succinic acid | 5 | stable | x | precipitate | x |
| 63*^{,2} | 2.5 | ascorbic acid | 5 | stable | x | precipitate | x |
| 64*^{,2} | 2.5 | malic acid | 5 | stable | x | precipitate | x |
| 65*^{,2} | 5.0 | citric acid | 5 | stable | x | precipitate | x |
| 66*^{,2} | 10.0 | citric acid | 5 | stable | x | precipitate | x |
| 67*^{,2} | 10.0 | citric acid | 4 | stable | x | precipitate | x |
| 68*^{,2} | 5.0 | succinic acid | 4.3 | stable | x | precipitate | x |
| 69*^{,2} | 10.0 | succinic acid | 5 | stable | x | Precipitate | x |
| 70*^{,2} | 5.0 | ascorbic acid | 5 | stable | x | Precipitate | x |
| 71*^{,2} | 10.0 | ascorbic acid | 5 | stable | x | Precipitate | x |
| 72*^{,2} | 5.0 | malic acid | 5 | stable | x | Precipitate | x |
| 73*^{,2} | 10.0 | malic acid | 5 | stable | x | Precipitate | x |

¹Wt. % VMA on the basis of total VMA plus PCE (Glenium ™ 51 polymer, BASF, 37 wt. % solids);
²KelcoCrete ™ Diutan Gum (CP Kelco);
*Comparative Example.

We claim:

1. An shelf stable aqueous compositions comprising one or more polysaccharide viscosity modifying additive, one or more polycarboxylate ether (PCE), and an acid chosen from organic acids having 1 hydroxy group or less, strong acids containing a single hydrogen, and ascorbic acids, wherein the pH value of the aqueous compositions is less than the pH of the PCE itself, and, further wherein, the aqueous compositions comprise more than 60 wt. %, based on the total solids in the composition, of the one or more polycarboxylate ether.

2. The aqueous composition as claimed in claim 1 comprising the polysaccharide viscosity modifying additive in an amount of from 1 to 40.1 wt. %, based on the total solids in the composition.

3. The aqueous composition as claimed in claim 1, wherein the polysaccharide viscosity modifying additive and the polycarboxylate ether solids of the composition may comprise more than 70 wt. % of the total solids of the composition.

4. The aqueous composition as claimed in claim 1, wherein the total solids in the aqueous composition ranges from 10 to 65 wt. %.

5. The aqueous composition as claimed in claim 1, wherein the polysaccharide viscosity modifying additive is chosen from cellulose ethers.

6. The aqueous composition as claimed in claim 5, wherein, the polysaccharide viscosity modifying additive is chosen from hydroxyalkyl-methyl-cellulose, hydroxyethyl cellulose (HEC) and ethyl hydroxyethyl cellulose (EHEC).

7. The aqueous composition as claimed in claim 1, wherein the acid is chosen from an organic acid having 1 hydroxy group or less is a monocarboxylic acid, a dicarboxylic acid, a ketocarboxylic acid, a hydroxy dicarboxylic acid, a polycarboxylic acid, a hydroxy polycarboxylic acid, a strong acid containing a single hydrogen, an ascorbic acid, and mixtures thereof.

8. The aqueous composition as claimed in claim 1, wherein the pH is from 1.0 to 6.0.

9. The aqueous composition as claimed in claim 8, wherein the pH is 5.5 or less.

10. A method of making the aqueous compositions as claimed in claim 1 comprising combining an aqueous mother liquor of a polycarboxylate ether with a powder of a polysaccharide viscosity modifying additive and the acid, in any order, in the presence of shear to form a visibly homogeneous composition.
